(19) United States
(12) Patent Application Publication
(10) Pub. No.: US 2024/0082993 A1
(43) Pub. Date: Mar. 14, 2024

(54) SERVICE TOOL

(71) Applicant: Joy Global Surface Mining Inc, Milwaukee, WI (US)

(72) Inventor: Mark Duellman, Slinger, WI (US)

(21) Appl. No.: 18/462,150

(22) Filed: Sep. 6, 2023

Related U.S. Application Data
(60) Provisional application No. 63/405,217, filed on Sep. 9, 2022.

(51) Int. Cl. B25B 21/00

(52) U.S. Cl. CPC B25B 21/002

(57) ABSTRACT

A tool is provided for servicing a gudgeon nut threadedly coupled to a gudgeon shaft for supporting a rotating frame of an industrial machine. The tool includes: an elongated body; a surface positioned adjacent an end of the elongated body, the surface configured to engage the gudgeon nut; a lever frame coupled to the elongated body and oriented in a direction that is perpendicular to a rotational axis of the gudgeon nut; and an actuator coupled to the lever frame, operation of the actuator applying a force on the lever frame in a direction tangential to the rotational axis of the gudgeon nut

### CROSS-REFERENCE TO RELATED APPLICATION

This application claims the benefit of co-pending, prior-filed U.S. Provisional Patent Application No. 63/405,217, filed Sep. 9, 2022, the entire contents of which are incorporated by reference.

### FIELD

The present disclosure relates to an industrial machine, such as a mining shovel, and more particularly to a tool for performing maintenance on an industrial machine.

### SUMMARY

In one independent aspect, a tool is provided for servicing a gudgeon nut threadedly coupled to a gudgeon shaft for supporting a rotating frame of an industrial machine. The tool includes: an elongated body; a surface positioned adjacent an end of the elongated body, the surface configured to engage the gudgeon nut; a lever frame coupled to the elongated body and oriented in a direction that is perpendicular to a rotational axis of the gudgeon nut; and an actuator coupled to the lever frame, operation of the actuator applying a force on the lever frame in a direction tangential to the rotational axis of the gudgeon nut.

In another independent aspect, a tool is provided for servicing a gudgeon nut coupled to a gudgeon shaft for supporting an upper portion of a chassis of an industrial machine for rotational movement relative to a lower portion of the chassis. The tool includes an elongated body including a first end, a second end, and a body axis extending therebetween; a surface positioned adjacent the first end of the body, the surface configured to engage an end of the gudgeon nut; a lever positioned adjacent the second end of the body, the lever protruding radially from the body axis and including a distal end spaced apart from the body axis by an offset distance; and an actuator operable to exert a force on the lever adjacent the distal end, operation of the actuator exerting a torque on the elongated body to rotate the elongated body about the body axis.

In yet another independent aspect, a method is provided for removing a gudgeon nut from a gudgeon shaft, the gudgeon shaft supporting an upper portion of a chassis of an industrial machine for rotation relative to a lower portion of a chassis. The method includes: securing a surface of a service tool to an axial end of the gudgeon nut, the service tool including a lever that is offset in an axial direction relative to the end of the gudgeon nut and extends in a radial direction relative to an axis of rotation of the gudgeon nut; and operating an actuator to exert a force on a distal end of the lever, the surface transmitting a torque to an axial end of the gudgeon nut.

Other aspects of the disclosure will become apparent by consideration of the detailed description and accompanying drawings.

### BRIEF DESCRIPTION OF THE DRAWINGS

FIG. 1 is a perspective view of an industrial machine.

FIG. 2 is a perspective view of the industrial machine of FIG. 1, with an upper portion separated from a lower portion.

FIG. 3 is a perspective view of the lower portion of the industrial machine of FIG. 1.

FIG. 4 is a perspective view of a service tool.

FIG. 5 is a perspective cross-sectional view of the service tool of FIG. 4, viewed along section 5-5, coupled to a gudgeon nut.

FIG. 6 is a lower perspective view of the service tool and the lower portion of the industrial machine of FIG. 3.

FIG. 7 is a cross-sectional view of a lower portion of the industrial machine of FIG. 3, viewed along section 7-7, with the service tool coupled to a gudgeon nut.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for the purpose of description and should not be regarded as limiting. Unless specified or limited otherwise, the terms “mounted,” “connected,” “supported,” and “coupled” and variations thereof are used broadly and encompass both direct and indirect mountings, connections, supports, and couplings. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

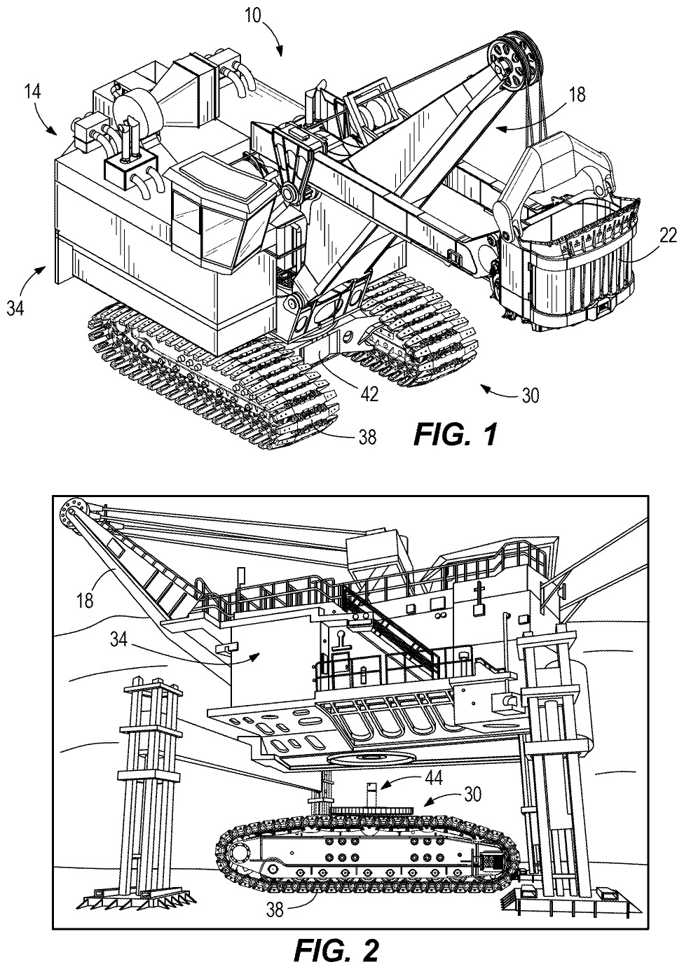

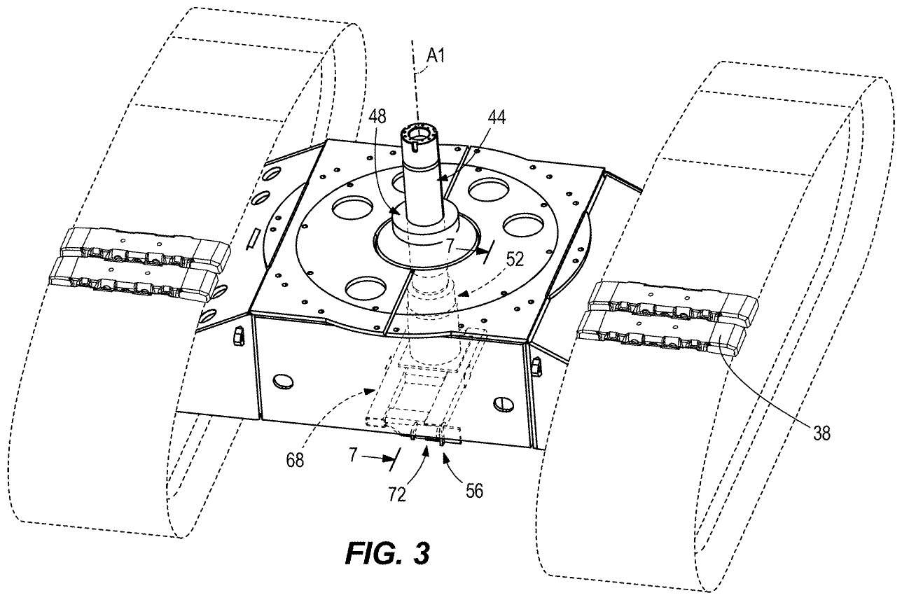

FIGS. 1 and 2 illustrate an industrial machine, for example a rope shovel 10. In the illustrated embodiment, the shovel 10 includes a main body 14 and a boom 18 coupled to the main body 14. The boom 18 supports a digging assembly, illustrated as a bucket or dipper 22, for performing a mining operation. The main body 14 of the shovel 10 includes a lower portion 30 and an upper portion 34. The lower portion 30 includes a traction drive system (e.g., a crawler track assembly 38) for moving the shovel 10 over a surface. The lower portion 30 also includes a carbody or chassis 42 to which the crawler track assembly 38 is coupled. The chassis 42 includes a center shaft or gudgeon shaft 44 for coupling the lower portion 30 to the upper portion 34. The gudgeon shaft 44 couples the lower portion 30 and upper portion 34 while allowing relative rotation between the upper portion 30 and lower portion 34. In some embodiments, the gudgeon shaft 44 is received within a bore 48 (FIG. 3) of the chassis 42 and is secured by a gudgeon nut 52 that is threadedly coupled to a lower end of the gudgeon shaft 44. Stated another way, the nut 52 is threaded onto a lower portion of the gudgeon shaft 44 to secure the upper portion 34 to the lower portion 30.

To service and/or repair certain components of the shovel 10, it may be necessary to separate the upper portion 34 from the lower portion 30 (FIG. 2), which may require removing or uncoupling the nut 52 from the gudgeon shaft 44. Over time, however, the nut 52 may become stuck or fused to the gudgeon shaft 44 and/or the chassis 42. In some circumstances, conventional methods for removing the nut 52 rely on gouging or cutting the nut 52 into multiple pieces. This method is time consuming and can be dangerous to those performing the work. Due to the small, confined space in which the nut 52 is located (e.g., the bore 48—FIGS. 3 and 7), removal of the nut 52 by gouging may take a team of multiple technicians (e.g., welders) several shifts to remove the nut 52. Therefore, the present disclosure provides a tool (e.g., a gudgeon wrench 56) for safely and efficiently removing the nut 52 without cutting the nut 52.

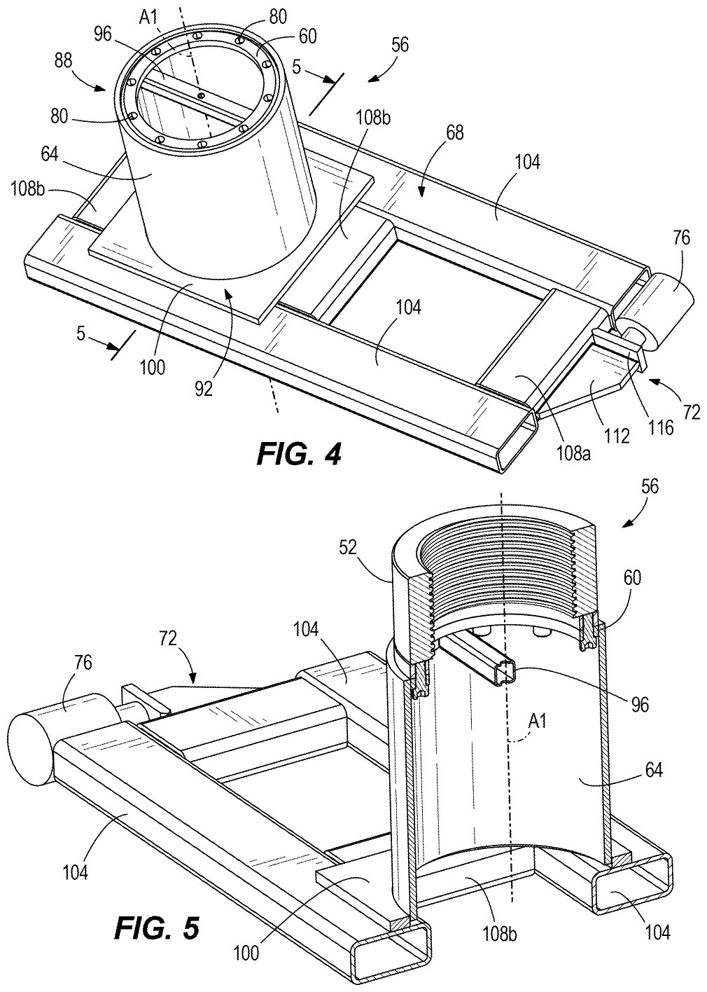

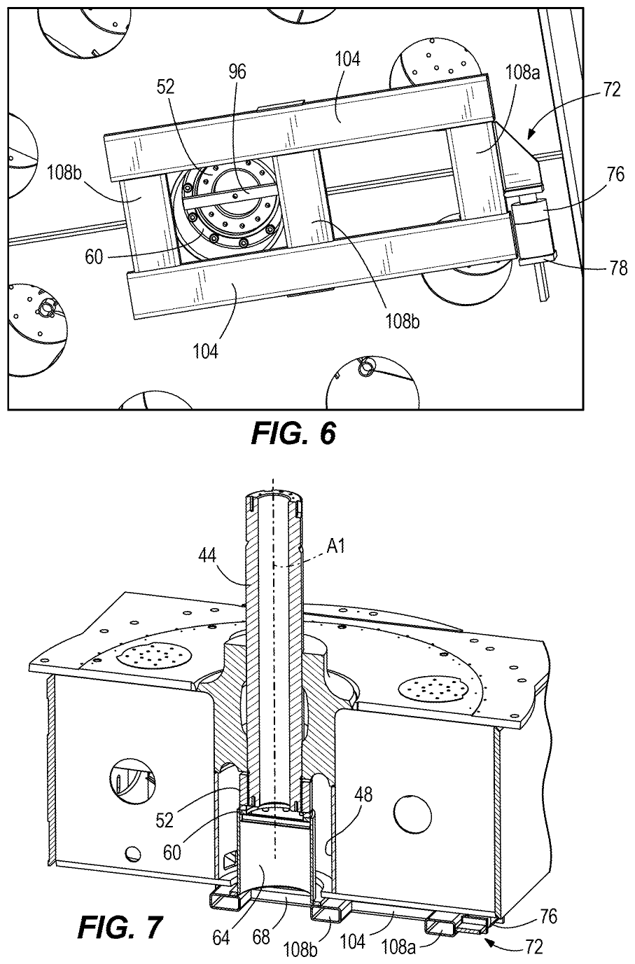

As shown in FIGS. 3-7, the gudgeon wrench 56 is capable of removing the nut 52, including in situations in which the nut 52 has become fused or stuck to the gudgeon shaft 44 or chassis 42. Referring to FIGS. 4 and 5, the wrench 56 includes a surface or mounting flange 60 for engaging the nut 52, a socket body 64 supporting the mounting flange 60, and a lever frame 68 (FIG. 4) coupled to the socket body 64 opposite the mounting flange 60. In the illustrated embodiment, the wrench 56 further includes a mount 72 supporting an actuator or ram 76 for providing a force to the lever frame 68. An end of the actuator 76 may be configured to contact a reaction surface 78 (FIG. 6). In some embodiments, a reaction surface may be temporarily secured to the chassis 42 while the wrench 56 is used.

The mounting flange 60 is securable to the nut 52 to transfer torque from the gudgeon wrench 56 to the nut 52. The flange 60 may be similar to the nut 52 in cross-sectional shape, and can be coupled to a bottom surface of the nut 52. In the illustrated embodiment, the mounting flange 60 and the nut 52 each have a circular cross-sectional profile as viewed along a rotational axis A1 of the nut 52. The mounting flange 60 of the illustrated embodiment includes a plurality of bores 80 spaced apart along a circumference of the flange 60. The bores 80 coincide with a plurality of tapped bores on the nut 52. To secure the flange 60 to the nut 52, a fastener is inserted into one of the bores 80 of the flange 60 and threaded into a corresponding tapped bore of the nut 52. Additional fasteners may be inserted into the other bores 80 of the flange and the bores of the nut 52, as needed. In other embodiments, the mounting flange 60 may be coupled to the nut 52 in a different manner (e.g., by welding). In the illustrated embodiment, the tool engages an end surface of the nut 52 (e.g., a surface of the nut 52 proximate an axial end of the gudgeon shaft 44) to apply a torque to rotate the nut 52.

With reference to FIGS. 4 and 5, the mounting flange is positioned adjacent an end of the socket body 64. The socket body 64 of the illustrated embodiment is a hollow cylindrical body sized and shaped to correspond to (e.g., fit within) the bore 48 (FIG. 7) in which the gudgeon shaft 44 and the gudgeon nut 52 are located. The socket body 64 may have a diameter that is smaller than that of the bore 48. The socket body 64 may include a first end 88 to which the mounting flange 60 is fixed and a second end 92, opposite the first end 88, to which the lever frame 68 is fixed. In the illustrated embodiment, the mounting flange 60 extends radially inwardly from the first end 88 of the socket body 64. The mounting flange 60 may be welded to the socket body 64 or may be secured via other means.

As shown in FIGS. 4 and 5, in the illustrated embodiment a brace 96 may be coupled to the socket body 64 adjacent the first end 88 and spans the diameter of the socket body 64. The brace 96 may provide a lifting point (e.g., to be lifted by an overhead crane) to position and hold the gudgeon wrench 56 in place during installation. Additionally, the brace 96 may increase the strength of the socket body 64 proximate the mounting flange 60. In some embodiments, the socket body 64 may include multiple braces; in other embodiments, the socket body may include no brace. Also, in the illustrated embodiment, the second end 92 may include a plate 100 to which the socket body 64 and the lever frame 68 are welded. The plate 100 may increases the rigidity/strength of the wrench 56 between the socket body 64 and the lever frame 68. However, in some embodiments, the second end 92 of the socket body 64 may be directly coupled to the lever frame 68. In yet other embodiments, the socket body 64 may be integrally formed with the lever frame 68.

In the illustrated embodiment, the lever frame 68 is rectangular in shape and extends in a plane that is generally perpendicular with respect to the rotational axis A1 (FIG. 4) of the nut 52. In the illustrated embodiment, the lever frame 68 includes two spaced apart longitudinal beams 104, and cross-braces 108 may extend between the longitudinal beams 104. The illustrated lever frame 68 includes a distal cross-brace 108a spanning between the longitudinal beams 104 at an end opposite the socket body 64, and two proximal cross-braces 108b spanning between the longitudinal beams 104 adjacent the socket body 64. The two proximal cross-braces 108b may be positioned on opposite sides of the socket body 64. Stated another way, the socket body 64 may be coupled to the lever frame 68 between the proximal cross-braces 108b. Also, in the illustrated embodiment, the mount 72 is positioned adjacent the distal cross-brace 108a. The mount 72 supports the actuator 76 in a direction tangential to the rotational axis A1 of the nut 52 to apply torque to the nut 52. In the illustrated embodiment, each of the longitudinal beams 104 and the cross-braces 108 are formed from rectangular steel tubing (e.g., box-shaped steel tubing) that are fixed or welded together.

The mount 72 may be fixed to the distal cross-brace 108a and supports the actuator 76, thereby exerting a torque on the wrench 56 that is transmitted to the nut 52. The mount 72 includes a base plate 112 coupled to the distal cross-brace 108a and support surface or plate 116 for receiving a force exerted by the actuator 76. In the illustrated embodiment, the support surface 116 is oriented in a plane parallel to the rotational axis A1 of the nut 52 and perpendicular to the lever frame 68 and to the base plate 112. By positioning the mount 72 adjacent the distal cross-brace 108a, the torque applied to the nut 52 (e.g., by impacts from the actuator 76) is increased. In other words, the mount 72 is positioned furthest from the rotational axis A1 of the nut 52 to increase the moment arm of the torque applied to the nut 52.

The actuator 76 of the illustrated embodiment may be a hydraulic ram and may utilize an auxiliary power source (not shown). For example, the actuator 76 may utilize a corded electric power source, a battery, or a hand pump to generate the necessary power to apply force to the lever frame.

In other embodiments, the actuator 76 may be supported separately from the wrench 56 and exert a force on the mount 72 in a direction tangential to the rotational axis A1 of the nut 52.

As shown in FIGS. 6 and 7, the gudgeon nut 52 may be positioned in a location having limited access (e.g., within the bore 48 of the lower portion 30 of the main body 14). The elongated socket body 64 can be positioned within the bore 48, and the mounting flange 60 can engage the end surface of the nut 52 (e.g., a lower surface of the nut 52 as shown in FIG. 7). The lever frame 68 may be positioned outside of the bore 48, and the actuator 76 may engage a reaction surface 78 (FIG. 6) to apply torque to the nut 52. In some embodiments, the reaction surface 78 may be a separate part that is temporarily secured to the chassis 42 (e.g., by welding, bolting, etc.) to engage the actuator 76 while the wrench 56 is in use, and the reaction surface 78 may be removed from the chassis 42 after the service operation is completed. In other embodiments, another portion of the machine may provide a reaction surface for the actuator 76. The actuator 76 may apply a force on the lever frame at an offset distance from the rotational axis A1, and the socket body 64 may have an axial length. In some embodiments, the axial length of the socket body is at least 25% the length of the offset distance. In some embodiments, the axial length of the socket body is at least 33% the length of the offset distance. In some embodiments, the axial length of the socket body is at least 40% the length of the offset distance.

To remove a nut 52, the mounting flange 60 is secured to the bottom of the nut 52. Power is then supplied to the actuator 76 to create the necessary torque to break the nut 52 loose and remove the nut 52 from the gudgeon 44. In the illustrated embodiment, the actuator 76 generates a force tangential to the rotational axis A1 which causes the lever frame 68 to rotate about the rotational axis A1 of the nut 52. Rotation of the lever frame 68 rotates the socket body 64 and the mounting flange 60, thus applying torque to the nut 52 to remove the nut 52 from the gudgeon 44. Once the nut 52 is removed, the gudgeon 44 is removable from the lower portion 30 to perform the necessary maintenance. Thus, the wrench 56 allows for removal of the nut 52 in a more efficient and safer manner than existing gouging/cutting methods. Furthermore, the wrench 56 may facilitate removal of the nut 52 without destruction of the nut 52.

Although the gudgeon wrench is described above in the context of a rope shovel 10, it is understood that the wrench may be used on other types of industrial machines that include a gudgeon nut or similar structure.

Although the disclosure has been described in detail with reference to certain preferred embodiments, variations and modifications exist within the scope and spirit of one or more independent aspects of the disclosure as described. Various features and advantages of the disclosure are set forth in the following claims.

What is claimed is:

1. A tool for servicing a gudgeon nut threadedly coupled to a gudgeon shaft for supporting a rotating frame of an industrial machine, the tool comprising:
an elongated body;
a surface positioned adjacent an end of the elongated body, the surface configured to engage the gudgeon nut;
a lever frame coupled to the elongated body and oriented in a direction that is perpendicular to a rotational axis of the gudgeon nut; and
an actuator coupled to the lever frame, operation of the actuator applying a force on the lever frame in a direction tangential to the rotational axis of the gudgeon nut.

2. The tool of claim 1, wherein the actuator is a linear actuator that is operable to extend and retract, extension of the actuator applying the force on the lever frame, the lever frame configured to transmit a torque to the gudgeon nut to rotate the gudgeon nut in a first direction about the rotational axis.

3. The tool of claim 1, wherein the elongated body is hollow and extends along an axis that is configured to be aligned with the rotational axis of the gudgeon nut while the surface engages the gudgeon nut.

4. The tool of claim 1, wherein the surface is configured to engage an end surface of the gudgeon nut and to transmit torque to the gudgeon nut through the end surface.

5. The tool of claim 4, further comprising a plurality of fasteners for coupling the surface to the gudgeon nut, each of the fasteners extending at least partially through the surface and at least partially through the gudgeon nut.

6. The tool of claim 1, wherein the surface is configured to be welded to an end surface of the gudgeon nut.

7. The tool of claim 1, wherein the lever frame includes two elongated members that are parallel to one another and spaced apart from one another, the lever frame further including a plurality of cross-braces extending between the elongated members.

8. The tool of claim 7, wherein the elongated members are formed from box-shaped tubing.

9. The tool of claim 1, wherein the lever frame is coupled to another end of the elongated body opposite the end adjacent the surface, the lever frame extending in a plane perpendicular to the axis of rotation, wherein the actuator is positioned adjacent an end of the lever frame that is opposite the elongated body, the actuator configured to exert a force against a surface of the industrial machine.

10. The tool of claim 1, wherein the actuator applies a force on the lever frame at an offset distance that is radially spaced apart from the rotational axis of the gudgeon nut, wherein the elongated body has a length that is at least 25% of the offset distance.

11. A tool for servicing a gudgeon nut coupled to a gudgeon shaft for supporting an upper portion of a chassis of an industrial machine for rotational movement relative to a lower portion of the chassis, the tool comprising:
an elongated body including a first end, a second end, and a body axis extending therebetween;
a surface positioned adjacent the first end of the body, the surface configured to engage an end of the gudgeon nut;
a lever positioned adjacent the second end of the body, the lever protruding radially from the body axis and including a distal end spaced apart from the body axis by an offset distance; and
an actuator operable to exert a force on the lever adjacent the distal end, operation of the actuator exerting a torque on the elongated body to rotate the elongated body about the body axis.

12. The tool of claim 11, wherein the elongated body is hollow and the body axis is configured to be aligned with the rotational axis of the gudgeon nut while the surface engages the end of the gudgeon nut.

13. The tool of claim 11, wherein the surface is configured to engage the end of the gudgeon nut and to transmit torque to the gudgeon nut through the end of the gudgeon nut.

14. The tool of claim 13, further comprising a plurality of fasteners for coupling the surface to the end of the gudgeon nut, each of the fasteners extending at least partially through the surface and at least partially through the gudgeon nut.

15. The tool of claim 11, wherein the lever includes two elongated members that are parallel to one another and spaced apart from one another, the lever further including a plurality of cross-braces extending between the elongated members.

16. The tool of claim 11, wherein the actuator applies a force on the lever at an offset distance that is radially spaced apart from the rotational axis of the gudgeon nut, wherein the elongated body has a length that is at least 25% of the offset distance.

17. A method for removing a gudgeon nut from a gudgeon shaft, the gudgeon shaft supporting an upper portion of a chassis of an industrial machine for rotation relative to a lower portion of a chassis, the method comprising:
securing a surface of a service tool to an axial end of the gudgeon nut, the service tool including a lever that is offset in an axial direction relative to the end of the gudgeon nut and extends in a radial direction relative to an axis of rotation of the gudgeon nut; and
operating an actuator to exert a force on a distal end of the lever, the surface transmitting a torque to the axial end of the gudgeon nut.

18. The method of claim 17, wherein securing the surface to the axial end of the gudgeon nut includes inserting a plurality of fasteners through openings of the surface and into the axial end of the gudgeon nut.

19. The method of claim 17, further comprising securing a reaction surface to the chassis, wherein operating the actuator includes extending a hydraulic ram to exert a force against the reaction surface.

20. The method of claim 17, further comprising inserting an elongated body of the tool into a bore in which the gudgeon nut is positioned to position the surface against the axial end of the gudgeon nut, the lever being positioned outside of the bore.
